(19) United States
(12) Patent Application Publication
(10) Pub. No.: US 2024/0325862 A1
(43) Pub. Date: Oct. 3, 2024

(54) FOOTBED AND METHOD FOR MANUFACTURING A FOOTBED

(71) Applicant: BAUER HOCKEY, LLC, Exeter, NH (US)

(72) Inventor: Thierry KRICK, Coteau-du-Lac (CA)

(21) Appl. No.: 18/617,924

(22) Filed: Mar. 27, 2024

Related U.S. Application Data
(60) Provisional application No. 63/492,421, filed on Mar. 27, 2023.

(51) Int. Cl. A63C 1/42; A63C 1/22; B29C 64/386

(52) U.S. Cl. CPC A63C 1/42; A63C 1/22; B29C 64/386

(57) ABSTRACT

A footbed and a method for manufacturing footbed for a skate of a player are provided. The method has the steps of: obtaining data from at least one of a scan of a foot and a plantar pressure map of the foot; obtaining a player position of a player for whom the footbed is to be manufactured; generating a virtual footbed model based on the data and the player position; and causing an additive manufacturing machine to manufacture, based on the virtual footbed model, the footbed for the hockey skate.

### CROSS-REFERENCE

The present application claims priority to U.S. Provisional Patent Application No. 63/492,421, filed on Mar. 27, 2023, the entirety of which is incorporated by reference.

### FIELD

The present technology relates to footbeds and methods for manufacturing footbeds.

### BACKGROUND

Footbeds are inserts provided inside shoes or boots that are used for cushioning and/or to provide a better fit. Footbeds are sometimes referred to as removable insoles or inner soles.

With all of the different footwear, and with all feet being different, most existing footbeds are a compromise designed to fit a majority of people or a majority of people within a certain category. FIG. 4 shows a prior art footbed 26 that can be used in an ice skate.

Some companies use scanning and 3D printing technology to design custom customized and/or bespoke footbeds for placing inside of shoes or boots intended for walking or running. However, such footbeds may not be suitable for specialized footwear such as ice skates since the forces and pressure applied by a foot inside an ice skate are different from those applied by a foot inside a shoe or boot to run or walk.

Therefore, there is a desire for a footbed and a method for designing and manufacturing a footbed suitable for specialized footwear such as skates.

### SUMMARY

It is an object of the present technology to ameliorate at least some of the inconveniences present in the prior art.

In accordance with a first broad aspect of the present technology, there is provided a method for manufacturing a footbed for a hockey skate including: obtaining data from at least one of a scan of a foot and a plantar pressure map of the foot; obtaining a player position of a player for whom the footbed is to be manufactured; generating a virtual footbed model based on the data and the player position; and causing an additive manufacturing machine to manufacture, based on the virtual footbed model, the footbed for the hockey skate.

In some implementations of the method, the player position is one of forward, defenseman and goalie.

In some implementations of the method, for a given scan of the foot and a given plantar pressure map, the virtual footbed model generated for the player position being goalie is at least one of: more cushioned in a region aligned with a ball region of the foot than for the player position being forward or defenseman; and designed for greater lateral push than for the player position being forward or defenseman.

In some implementations of the method, the generating the virtual footbed model comprises adjusting at least one of a size and a location of an arch portion of the virtual footbed model based on the data.

In some implementations of the method, the generating the virtual footbed model comprises increasing a density of the virtual footbed model in regions of the virtual footbed model corresponding to regions of higher pressure in the plantar pressure map.

In some implementations of the method, the additive manufacturing machine is a selective laser sintering printer.

In accordance with a second broad aspect of the present technology, there is provided a footbed manufactured according to the above method.

In some implementations of the footbed, the footbed comprises a pushing plate region in alignment with a ball region of the foot; and wherein a lattice-type of the pushing plate region differs from a lattice-type of other regions of the footbed.

In some implementations of the footbed, a top of the footbed is a closed surface; and a bottom of the footbed exposes a lattice of the footbed.

In some implementations of the footbed, walls of at least one portion of a lattice of the footbed are angled at an angle generally corresponding to an angle of a force applied by a foot of a skater for whom the footbed is designed on the at least one portion.

In accordance with a third board aspect of the present technology, there is provided a method for manufacturing a footbed for a skate of a player. The method comprises: sensing, using a plantar pressure sensor, pressure applied by a foot of the player on a work surface of the plantar pressure sensor, thereby generating a plantar pressure map, the work surface being positioned at a given angle relative to a ground surface; generating, based on the plantar pressure map, a virtual footbed model; and causing an additive manufacturing machine to manufacture, based on the virtual footbed model, the footbed for the player.

In some implementations of the method, comprises obtaining data from a scan of the foot; and the generating the virtual footbed model comprises generating the virtual footbed model based on the plantar pressure map and the scan.

In some implementations of the method, the given angle of the work surface is determined based at least in part on a skating stride of the player.

In some implementations of the method, the generating the virtual footbed model further comprises adjusting at least one of a size and a location of an arch portion of the virtual footbed model based on the plantar pressure map.

In some implementations of the method, the generating the virtual footbed model further comprises increasing a density of the virtual footbed model in regions of the virtual footbed model corresponding to regions of higher pressure in the plantar pressure map.

In some implementations of the method, prior to the sensing, the method further comprises positioning the work surface of the plantar pressure sensor at the given angle relative to the ground surface.

In some implementations of the method, prior to the sensing, the method further comprises: obtaining data of the skating stride of the player; determining, based on the skating stride, the given angle for positioning the work surface of the plantar pressure sensor relative to the ground surface; and repositioning the work surface of the plantar pressure sensor from a preliminary angle to the given angle relative to the ground surface.

In some implementations of the method, prior to the sensing, the method further comprises calibrating the plantar pressure sensor for sensing the pressure at the given angle.

In some implementations of the method, the method further comprises modifying the given angle to an other angle, the other angle being different from the given angle; repositioning the work surface of the plantar pressure sensor to an other angle relative to the ground surface; sensing, using the plantar pressure sensor, pressure applied by the foot of the player on the work surface positioned at the other angle relative to the ground surface, thereby generating an other plantar pressure map; and the generating the virtual footbed model comprises generating the virtual footbed model based on a combination of the plantar pressure map and the other plantar pressure map.

In some implementations of the method, the additive manufacturing machine is a selective laser sintering printer.

In accordance with a third broad aspect of the present technology, there is provided a footbed manufactured according to the above method.

In some implementations of the footbed, a pushing plate region in alignment with a ball region of the foot; and wherein a lattice-type of the pushing plate region differs from a lattice-type of other regions of the footbed.

In some implementations of the footbed, a top of the footbed is a closed surface; and a bottom of the footbed exposes a lattice of the footbed.

In some implementations of the footbed, walls of at least one portion of a lattice of the footbed are angled at an angle generally corresponding to an angle of a force applied by a foot of a skater for whom the footbed is designed on the at least one portion.

In accordance with a fifth broad aspect of the present technology, there is provided a method for manufacturing a footbed for footwear comprising: obtaining data regarding a shape of an inner perimeter of the footwear; obtaining data from at least one of a scan of a foot and a plantar pressure map of the foot; generating a virtual footbed model based on the data regarding the shape and the data from the at least one of the scan of the foot and the plantar pressure map of the foot; and causing an additive manufacturing machine to manufacture, based on the virtual footbed model, the footbed for the footwear.

In some implementations of the method, the obtaining data regarding the shape of the inner perimeter of the footwear comprises: obtaining a model of the footwear; and obtaining a size of the footwear.

In some implementations of the method, the obtaining data regarding the shape of the inner perimeter of the footwear comprises: obtaining data regarding a shape of an outer perimeter of a last used to make the footwear.

In some implementations of the method, the generating the virtual footbed model comprises adjusting at least one of a size and a location of an arch portion of the virtual footbed model based on the data.

In some implementations of the method, the generating the virtual footbed model comprises increasing a density of the virtual footbed model in regions of the virtual footbed model corresponding to regions of higher pressure in the plantar pressure map.

In some implementations of the method, the additive manufacturing machine is a selective laser sintering printer.

In accordance with a sixth broad aspect of the present technology, there is provided a footbed manufactured according to the above method.

In some implementations of the foot bed, the footbed comprises a pushing plate region in alignment with a ball region of the foot; and a lattice-type of the pushing plate region differs from a lattice-type of other regions of the footbed.

In some implementations of the foot bed, a top of the footbed is a closed surface; and a bottom of the footbed exposes a lattice of the footbed.

In some implementations of the foot bed, walls of at least one portion of a lattice of the footbed are angled at an angle generally corresponding to an angle of a force applied by a foot of a skater for whom the footbed is designed on the at least one portion.

It must be noted that, as used in this specification and the appended claims, the singular form “a”, “an” and “the” include plural referents unless the context clearly dictates otherwise.

As used herein, the term “and/or” is to be taken as specific disclosure of each of the two specified features or components with or without the other. For example, “A and/or B” is to be taken as specific disclosure of each of (i) A, (ii) B and (iii) A and B, just as if each is set out individually herein.

For purposes of the present application, terms related to spatial orientation when referring to a skate, such as “vertical”, “horizontal”, “forwardly”, “rearwardly”, “left”, “right”, “above” and “below”, are as they would be understood by a person wearing the skate on flat, level ground.

Embodiments of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of embodiments of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 is a perspective view taken from a front, right side of an ice skate, in accordance with certain non-limiting embodiment of the present technology;

FIG. 2 is a perspective view of a human foot with the integument of the foot shown in stippled lines and the bones of the foot shown in solid lines;

FIG. 3 is a front view of the foot of FIG. 2;

FIG. 4 is a perspective view taken from a top, front, left side of a prior art footbed;

FIG. 5 is a perspective view taken from a bottom, front, right side of a footbed according to the present technology;

FIG. 6 is a perspective view taken from a top, front, left side of the footbed of FIG. 5;

FIG. 7 is a schematic representation of a method for designing and manufacturing the footbed of FIG. 5, in accordance with certain non-limiting embodiment of the present technology;

FIG. 8 is a front view of a hockey player illustrating a skating stride and an angle of a force applied by a foot during skating;

FIG. 9 is a schematic representation of a foot pressure sensing system used to generate a plantar pressure map, in accordance with certain non-limiting embodiment of the present technology;

FIG. 10 is an exemplary plantar pressure map, in accordance with certain non-limiting embodiment of the present technology;

FIG. 11 is a top view of a virtual footbed model overlayed on the plantar pressure map of FIG. 10, with a solid top surface of the virtual footbed model removed to show the lattice of the model, in accordance with certain non-limiting embodiment of the present technology;

FIG. 12 is a top view of virtual footbed models having an arch portion in different positions, in accordance with certain non-limiting embodiment of the present technology;

FIG. 13A is a top view of a heel portion of a virtual footbed model having thicker walls compared to a heel portion of a reference virtual footbed shown in FIG. 13B, with solid top surfaces of the virtual footbed models removed to show the lattice of the models, in accordance with certain non-limiting embodiment of the present technology;

FIG. 14A is a top view of a heel portion of a virtual footbed model having thinner walls compared to a heel portion of a reference virtual footbed shown in FIG. 14B, with solid top surfaces of the virtual footbed models removed to show the lattice of the models, the reference virtual footbeds of FIGS. 13B and 14B being the same, in accordance with certain non-limiting embodiment of the present technology;

FIG. 15 illustrates various lattice types for producing the footbed of FIG. 5, in accordance with certain non-limiting embodiment of the present technology;

FIG. 16 is a top view of a virtual footbed model having a solid pushing plate region, with a solid top surface of the virtual footbed model removed to show the lattice of the model, in accordance with certain non-limiting embodiment of the present technology;

FIG. 17 is a top view of a virtual footbed model having a pushing plate region with a honeycomb lattice with constant thickness walls, with a solid top surface of the virtual footbed model removed to show the lattice of the model, in accordance with certain non-limiting embodiment of the present technology;

FIG. 18 is a top view of a virtual footbed model having a pushing plate region with a honeycomb lattice with variable thickness walls, with a solid top surface of the virtual footbed model removed to show the lattice of the model, in accordance with certain non-limiting embodiment of the present technology;

FIG. 19 is a top view of a virtual footbed model showing a customization feature, in accordance with certain non-limiting embodiment of the present technology;

FIGS. 20A and 20B are top and bottom views, respectively, of an alternative embodiment of a virtual footbed;

FIGS. 21A to 21C are front, perspective and top views respectively of a portion of a virtual footbed model having a honeycomb lattice having angled walls, in accordance with certain non-limiting embodiment of the present technology;

FIGS. 22A to 22C are front, perspective and top views respectively of a portion of a virtual footbed model having a honeycomb lattice having vertical walls, in accordance with certain non-limiting embodiment of the present technology;

FIG. 23 illustrates perspective and left side views of a virtual footbed model showing features of an arch region of the virtual footbed model, in accordance with certain non-limiting embodiment of the present technology;

FIG. 24 illustrates a perspective view of a virtual footbed model having a solid arch region (top left image) and perspective, left side and bottom views of a virtual footbed model having a latticed arch region, in accordance with certain non-limiting embodiment of the present technology;

FIG. 25 is a perspective view of multiple footbeds produced during a common additive manufacturing operation, in accordance with certain non-limiting embodiment of the present technology;

FIG. 26 is a top view thereof;

FIG. 27 depicts a schematic diagram of an example computer system for implementing certain non-limiting embodiments of systems and/or methods of the present technology including the method of FIG. 7; and

FIG. 28 depicts a flowchart diagram of another method for manufacturing the footbed for a skate of a player, in accordance with certain non-limiting embodiment of the present technology.

### DETAILED DESCRIPTION

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including”, “comprising”, or “having”, “containing”, “involving” and variations thereof herein, is meant to encompass the items listed thereafter as well as, optionally, additional items. In the following description, the same numerical references refer to similar elements.

The present technology will be described with reference to a footbed for an ice skate. It is contemplated that aspects of the present technology could be used in footbeds for roller skates, ski boots, shoes, boots, and other types of footwear in which footbeds could be used.

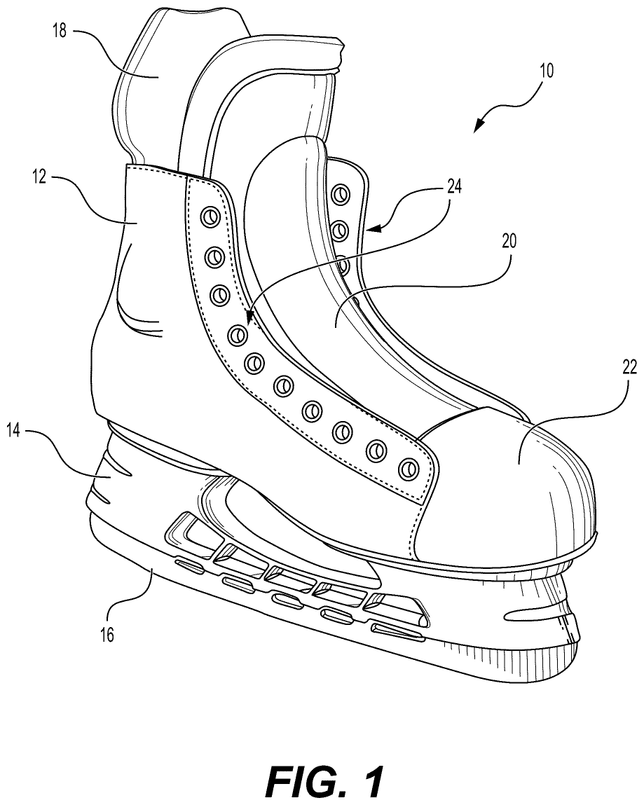

With reference to FIG. 1, an ice skate 10, and more specifically a hockey skate 10, has a skate boot 12, a blade holder 14 connected to a bottom of the skate boot 12, and a blade 16 held in the blade holder 14. The skate boot 12 has a tendon guard 18, a tongue 20, a toe cap 22 and eyelets 24. A lace (not shown) passes through the eyelets 24.

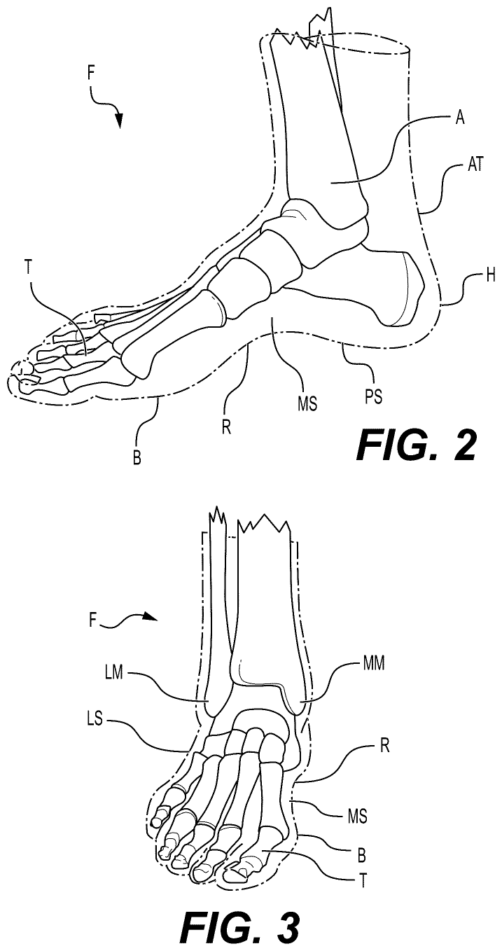

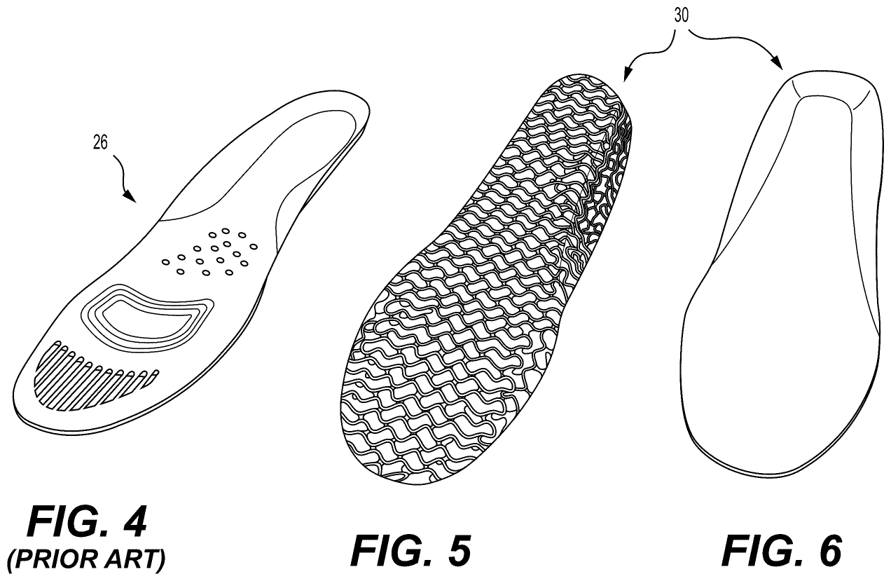

With reference to FIGS. 2 and 3, a typical human foot F has a heel H and an Achilles tendon AT. The foot F also has a plantar surface PS, a medial side MS, a lateral side LS, toes T, and an ankle A with a medial malleolus MM and a lateral malleolus LM. The lateral malleolus LM is lower than the medial malleolus MM. The foot F also has an arch R and a ball B.

FIGS. 5 and 6 show a custom footbed 30 according to the present technology that can be used in the ice skate 10. As can be seen, the top of the custom footbed 30 is a closed surface and a bottom of the custom footbed 30 exposes a lattice of the custom footbed 30. It is contemplated that the top of the custom footbed 30 or at least a part thereof could expose the lattice of the custom footbed 30. It is contemplated that the bottom of the custom footbed 30 or at least a part thereof could be a closed surface.

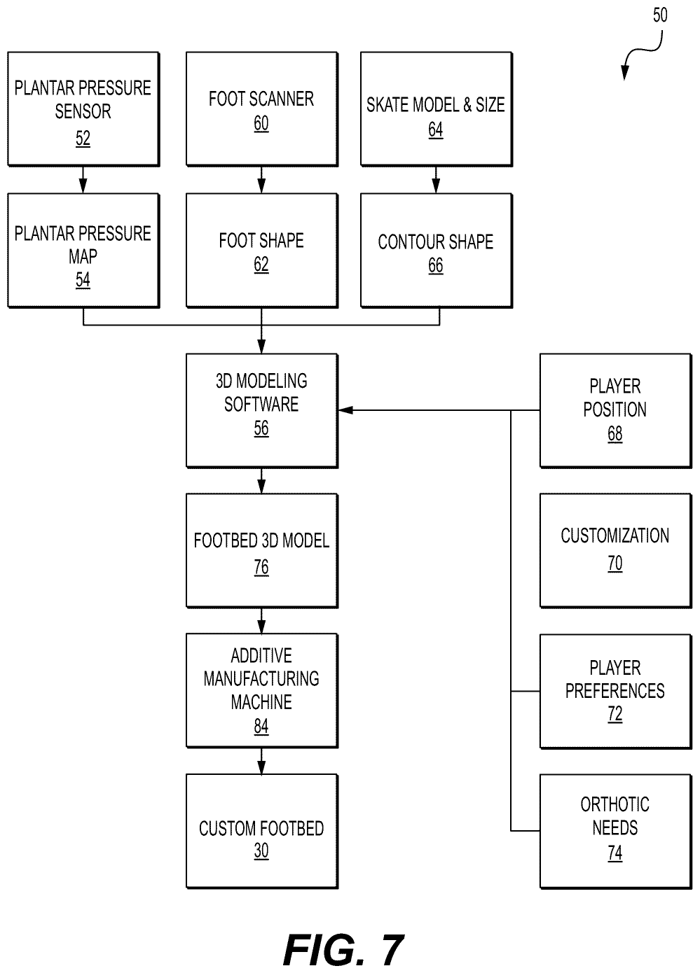

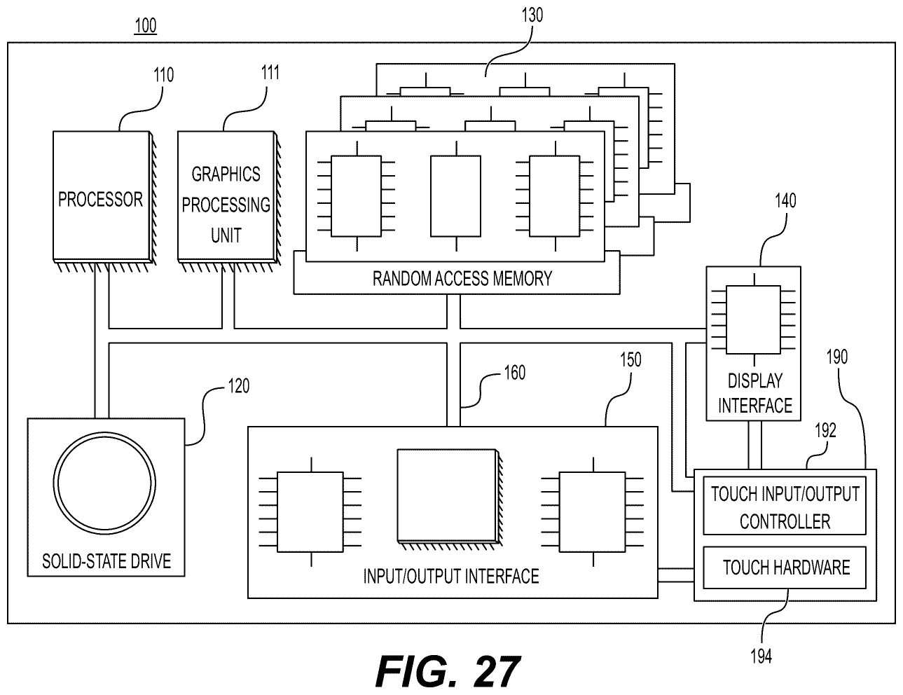

With reference to FIG. 7, a method 50 for designing and manufacturing a footbed such as the custom footbed 30 will be described. It is contemplated that some portions of the method described below could be omitted and that some portions could be added to the method. In some non-limiting embodiments of the present technology, the method of 50 can be executed by a processor 110 of a computer system 100, which will be described hereinbelow with reference to FIG. 27. In some non-limiting embodiments of the present technology, the processor 110 can be communicatively coupled to a plantar pressure sensor 52 and a foot scanner 60 via a respective suitable communication link. In various non-limiting, the respective communication link can be one of a wired communication link and a wireless communication link.

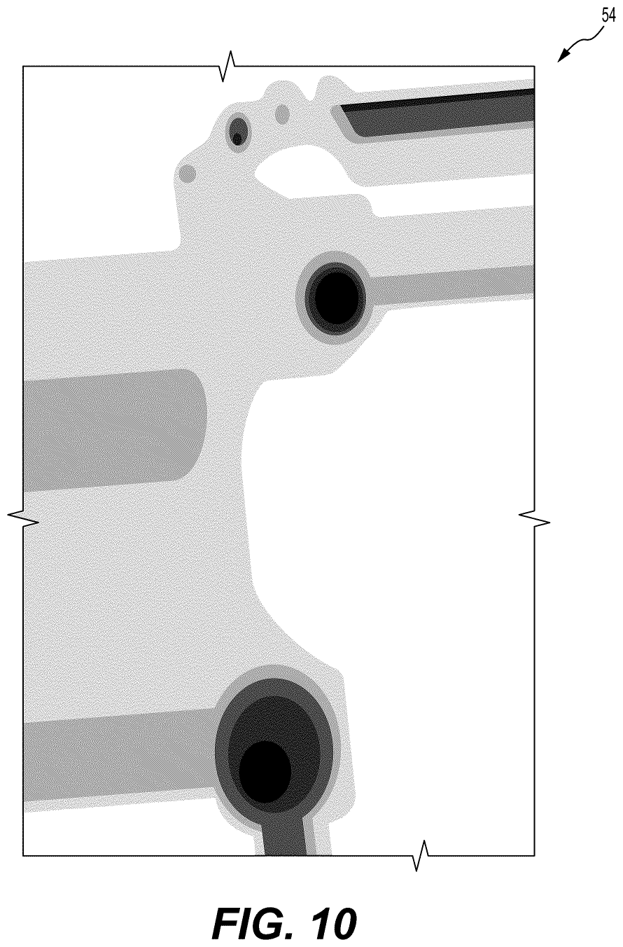

In some non-limiting embodiments of the present technology, the processor 110 can be configured to cause the plantar pressure sensor 52 to generate a plantar pressure map 54 of a foot of a person for whom the footbed is to be designed, an example of which is shown in FIG. 10. Different shades of grey of the map 54 correspond to different pressures. In the example of FIG. 10, the highest pressures are at the heel and at the medial side of the ball of the foot. Further, the processor 110 can be configured to execute a 3D modelling software 56, which is configured, based on data from the plantar pressure map to generate a virtual footbed model for the footbed. It is contemplated that the plantar pressure sensor 52 could additionally sense pressures in three-dimensions on other parts of the foot in order to generate a 3D pressure map that includes the plantar pressure map 54. In a specific non-limiting example, the 3D modeling software 56 is an nTop Platform™ from nTopology Inc. However, it should be expressly understood that use of other software platforms configured to generate footbed 3D models is contemplated.

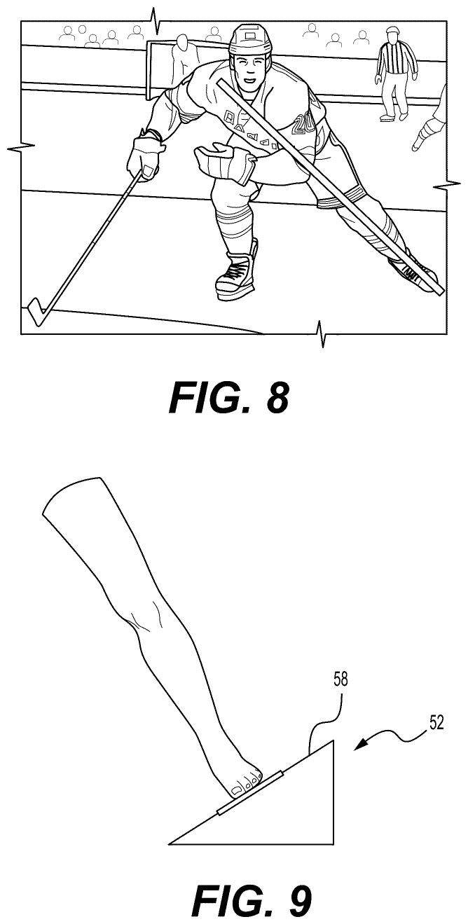

With reference to FIG. 9, in one embodiment, a work surface of the plantar pressure sensor 52, on which the foot is to positioned for generating a respective plantar pressure map, can be positioned at an angle relative to a ground surface on which the plantar pressure sensor 52 is disposed. In this case, the work surface is referred to herein as “an angled surface,” such as an angled surface 58. As can be seen in FIG. 8, compared to walking or running where the pressure applied by the foot is generally vertical, during ice skating the pressure applied by the foot is at an angle since the skater pushes laterally. As such, by having the angled surface 58 at an angle, the plantar pressure map 54 provides a more accurate representation of the pressures generated during skating. It is contemplated that in some embodiments, the skating stride of the skater for whom the custom footbed 30 is being designed and manufactured could be analyzed and the angle of the angled surface 58 could be adjusted based at least in part of this skating stride. Alternatively, it is contemplated that pressure sensors could be provided in ice skates and that the plantar pressure map 54 could be generated from data generated while the skater for whom the custom footbed 30 is being designed skates with the skates provided with the pressure sensors, thereby providing dynamic pressure measurements.

Thus, prior to generating the plantar pressure map 54, when the angled surface 58 is at some preliminary angle relative to the ground surface, the processor 110 can be configured to: (i) obtain, such as from a database or an operator of the computer system 100, data of the skating stride of the person for whom the custom footbed 30 is to be manufactured; (ii) determine, based on the skating stride associated with the person, a given angle for positioning the angled surface 58 relative to the ground surface; and (iii) cause the plantar pressure sensor 52 to position the angled surface 58 at the given angle relative to the ground surface. Further, the processor 110 can be configured to cause the plantar pressure sensor 52 to generate the plantar pressure map 54 of the foot of the person while the angled surface 58 is positioned at the given angle associated with the skating stride of that person.

As an angle of the angled surface 58 of the plantar pressure sensor 52 can be changed, such as by repositioning the angled surface 58 at another angle, in some non-limiting embodiment of the present technology, prior to causing the plantar pressure sensor 52 to sense the pressure applied to the angled surface 58 positioned at the given angle, the processor 110 can be configured to calibrate the plantar pressure sensor 52 for measuring the pressure at the given angle.

Further, in some non-limiting embodiments of the present technology, the processor 110 can be configured to cause the foot scanner 60 to generate a foot shape 62 of the foot of the person for whom the custom footbed 30 is to be designed. In some embodiments, the foot scanner 60 is a 3D scanner that generates a 3D virtual model of the foot shape 62. It is contemplated that in some embodiments, a single device could combine the functions of the plantar pressure sensor 52 and the foot scanner 60. Further, in some non-limiting embodiments of the present technology, the processor 110 can be configured to cause data representative of the foot shape 62 to be input to the 3D modeling software 56.

Further, using the 3D modelling software 56, based on the plantar pressure map 54 generated by the plantar pressure sensor 52 and the 3D model of the foot shape 62 generated by the foot scanner 60, the processor 110 can be configured to generate a topography and other features of the custom footbed 30 to be designed, as will be described below. It is contemplated that in some embodiments the data from the plantar pressure map 54 or the data the from the scan of the foot (i.e., the foot shape 62) could be omitted.

According to certain non-limiting embodiments of the present technology, at step 64 of the method 50, the processor 110 can be configured to acquire a model and size of the ice skate 10 for which the custom footbed 30 is to be designed. Based on this data, the processor 110 can further be configured to acquire from a database (not separately depicted) specific data regarding a shape of an inner perimeter (i.e., a contour shape 66) of the skate boot of the ice skate 10 for which the custom footbed 50 is to be designed. Data regarding the contour shape 66 can be obtained by physically measuring an interior of each skate model and size for which the custom footbed 30 could be designed using the method 50, by scanning the interior of each of these skate models and sizes, or by physically measuring or scanning an exterior of lasts used to make the skate boots of each of these skate models and sizes. It is contemplated that the skate boot or last being measured or scanned could be a mass produced skate boot or last or a custom designed skate boot or last. Further, the data of the contour shape 66 is provided to the processor 110 executing the 3D modeling software 56.

Using the data regarding the shape of an inner perimeter (i.e., the contour shape 66) of the skate boot of the ice skate for which the custom footbed 30 is to be designed, the 3D modeling software 56 can be configured to generate a virtual footbed model. As a result, the custom footbed 30 manufactured from this virtual footbed model closely fits the shape of the inner perimeter of the skate boot of the ice skate 10 and does not move inside the skate boot during use, thereby ensuring comfort and proper alignment of the various features of the custom footbed 30with the foot of the wearer of the ice skate.

The player position 68 of the person for whom the custom footbed 30is to be designed is also provided to the 3D modeling software 56. In ice hockey, these player positions are forward, defenseman and goalie. Using the player position 68, the 3D modeling software 56 can be configured to adjust the virtual footbed model to meet requirements of the player position 68. For example, for the same plantar pressure map 54, same foot shape 62 and same contour shape 66, the virtual footbed model is more cushioned and/or is designed for greater lateral push when the player position 68 is goalie than when the player position 68 is forward or defenseman. This is because a forward or defenseman tends to skate mostly forward compared to a goalie that tends to make more lateral displacements. As such, for a forward or defenseman, the virtual footbed model will have a thin and/or rigid region that aligns with the ball B of the foot to enhance the force transmission from the foot to the ice skate to the ice while skating forward, whereas this region can be thicker and more cushioned for a goalie, thereby improving comfort. In the virtual footbed model for a goalie, the virtual footbed model will have rigid regions that align with the medial side MS and the lateral side LS to enhance the force transmission from the foot to the ice skate to the ice while making lateral displacement. For example, the arch portion of the virtual footbed could be more rigid for a goalie than for a forward or defenseman. Similarly, the heel portion of a virtual footbed for a defenseman could differ from the heel portion of a virtual footbed for a forward since the defenseman skates more often backwards than the forward. It is also contemplated that instead of providing the player position 68 to the 3D modeling software 56, an intended use of the ice skate 10 could be provided to the 3D modeling software 56. The intended use could include recreational skating, figure skating and hockey, for example. The 3D modeling software 56 can the adjust the virtual footbed model to meet requirements of the intended use of the ice skate 10.

Further, in some non-limiting embodiments of the present technology, the processor 110 can be configured to acquire and provide to the 3D modeling software 56 one or more customization features 70 so that they can be integrated in the virtual footbed model. For example, as shown in FIG. 19, the customization features 70 can be a logo to be recessed in the top surface of the custom footbed 30. The customization features 70 can also include, but are not limited to, a top surface pattern, a top surface finish, player name and/or number and footbed identification number for linking the custom footbed 30 to the footbed order.

In some non-limiting embodiments of the present technology, the processor 110 can be configured to acquire and provide to the 3D modeling software 56 player preferences 72 and orthotic needs 74 so that they can be considered in the virtual footbed model. According to certain non-limiting embodiments of the present technology, the player preferences 72 correspond to individual preferences of the person for whom the custom footbed 30 is to be manufactured such as, but not limited to, more or less cushioning, thickness profiles, color, and the like. The orthotic needs 74 can include, without limitation, pronation, supination, plantar fasciitis, and hallux valgus (bunion).

Based on the data obtained from at least one of the plantar pressure map 54, the foot shape 62, the contour shape 66, the player position 68, the customization features 70, player preferences 72, and the orthotic needs 74, the processor 110 executing the 3D modeling software 56 can be configured to generate the virtual footbed model as a footbed 3D model 76.

Also, in some non-limiting embodiments of the present technology, the processor 110 executing the 3D modeling software 56 can be configured to generate the footbed 3D model 76 for the custom footbed 30 based on more than one plantar pressure maps. More specifically, in these embodiments, the processor 110 can be configured to: (i) modify the given angle, based on which the plantar pressure map 54 has been generated, thereby determining another angle, the other angle being different from the given angle; (ii) reposition the angled surface 58 at the other angle relative to the ground surface, on which the plantar pressure sensor 52 is disposed; (iii) cause the plantar pressure sensor 52 to generate another plantar pressure map (not separately depicted) while the angled surface 58 is positioned at the other angle relative to the ground surface; and (iv) generate the footbed 3D model 76 based on a combination of the plantar pressure map 54 and the other plantar pressure map. In some non-limiting embodiments of the present technology, the combination of the plantar pressure map 54 and the other plantar pressure map can comprise an average plantar pressure map thereof.

According to certain non-limiting embodiments of the present technology, based on the above-mentioned data, the 3D modeling software 56 can be configured to generate lattice of the footbed 3D model 76. According to certain non-limiting embodiments of the present technology, the processor 110 can be configured to determine characteristics of the lattice are based on the data obtained from at least one of the plantar pressure map 54, the foot shape 62, the contour shape 66, the player position 68, the customization features 70, player preferences 72, and the orthotic needs 74, the type of material used for manufacturing the footbed, and the type of additive manufacturing machine used. It is contemplated that other aspects could be taken into consideration.

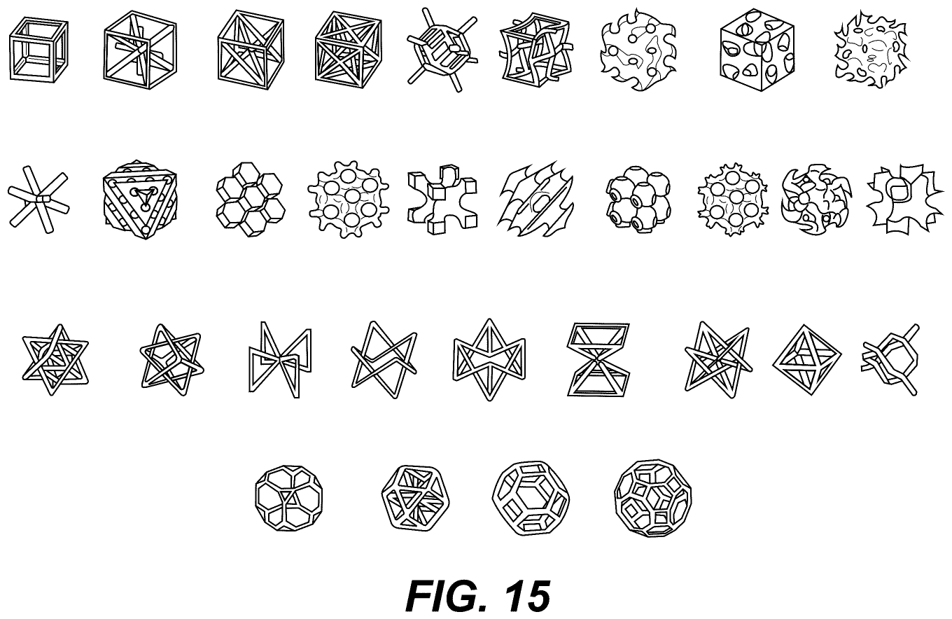

With reference to FIG. 15, different types of lattices can be used by the 3D modeling software 56. The type of lattice structure, the size of the lattice structures, a thickness of the members forming the lattice structures, and an orientation of the lattice structures can be adjusted by the 3D modeling software 56 in order to obtain the desired shape, cushioning, and pressure resistance. In the present embodiment, a triply periodic minimal surface (TPMS) lattice is used, but other types are contemplated.

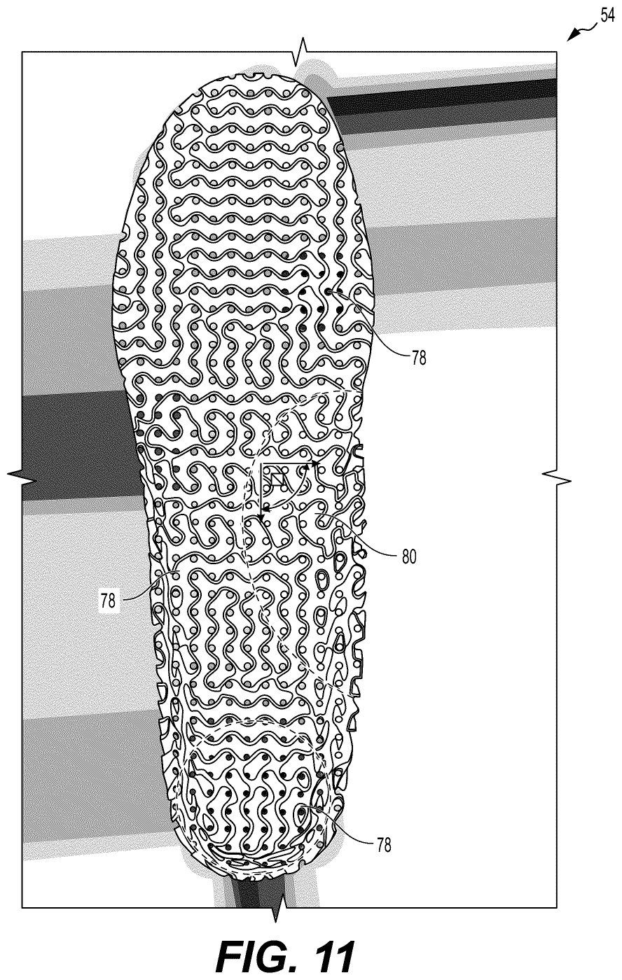

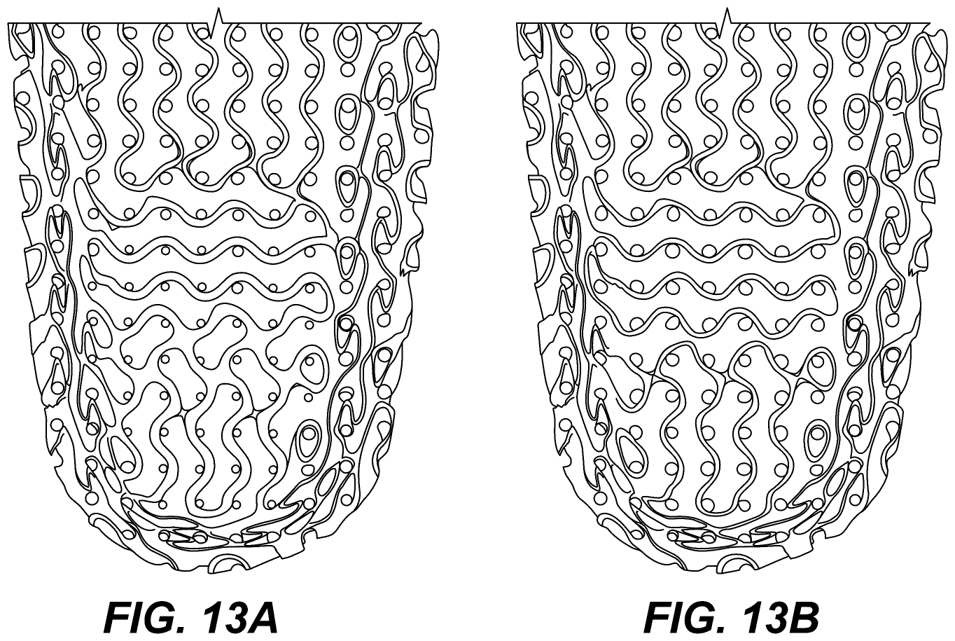

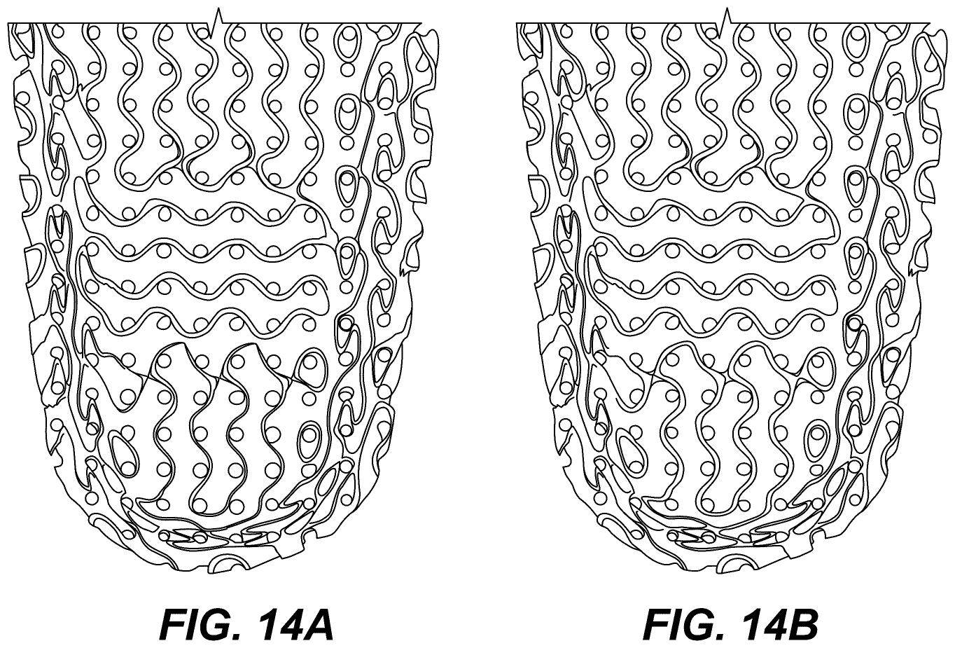

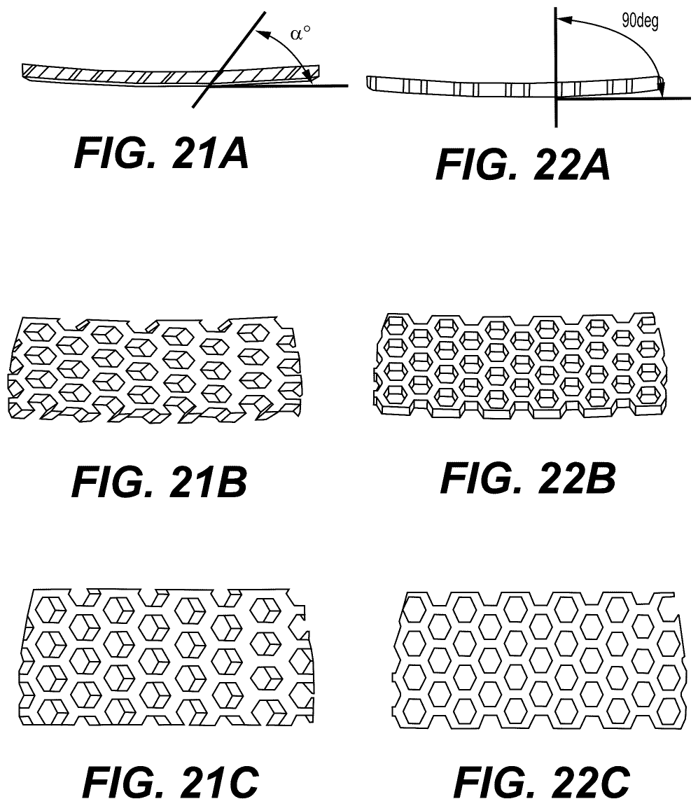

As shown in FIG. 11, in some embodiments, the processor 110 executing the 3D modeling software 56 can be configured to increase the density of regions 78 of the footbed 3D model 76 corresponding to regions of high pressure in the plantar pressure map 54. With comparison to a reference virtual footbed model shown in FIGS. 13B and 14B, FIG. 13A shows heel portion of the footbed 3D model 76 having thicker walls and FIG. 14A shows a heel portion of the footbed 3D model 76 having thinner walls. The thicker walls of the footbed 3D model 76 as depicted in FIG. 13A provide more cushioning and therefore more comfort; and the thinner walls of the footbed 3D model 76 as depicted in FIG. 14A provide less cushioning and therefore more force is transferred from the foot to the ice skate, to the ice. With refence to FIGS. 22A to 22C, in some embodiments, in at least a portion of the footbed 3D model 76, the walls of the lattice of the virtual footbed model, in this case a honeycomb lattice, are vertical. With refence to FIGS. 21A to 21C, in some embodiments, in at least a portion of the virtual footbed model, the walls of the lattice of the footbed 3D model 76, in this case a honeycomb lattice, are angled at an angle generally corresponding to an angle of a force applied by a foot of a skater (see FIG. 8) for whom the custom footbed 30 is designed. In some embodiments, a density of the lattice structure is greater at the bottom of the footbed 3D model 76 than at the top of the footbed 3D model 76 and increases gradually from the top to the bottom.

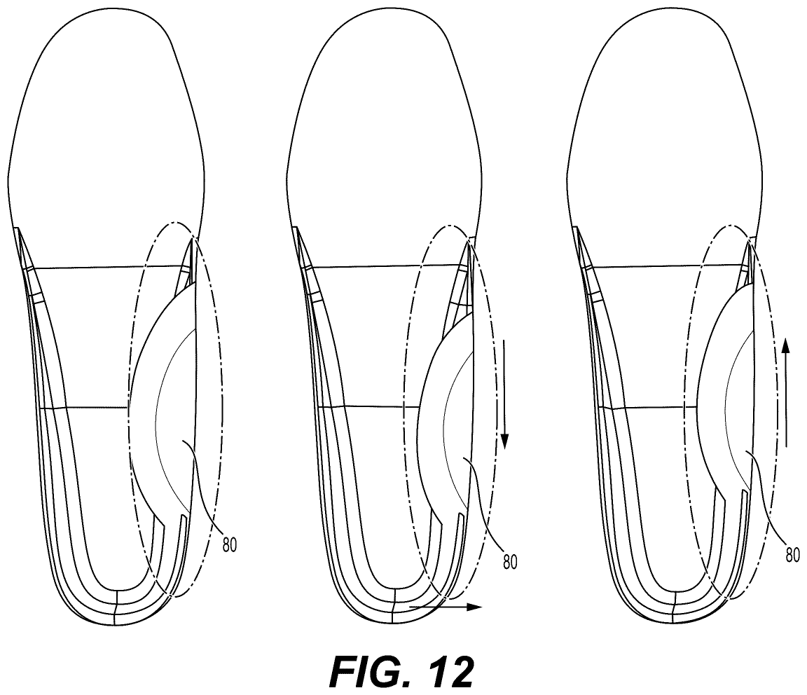

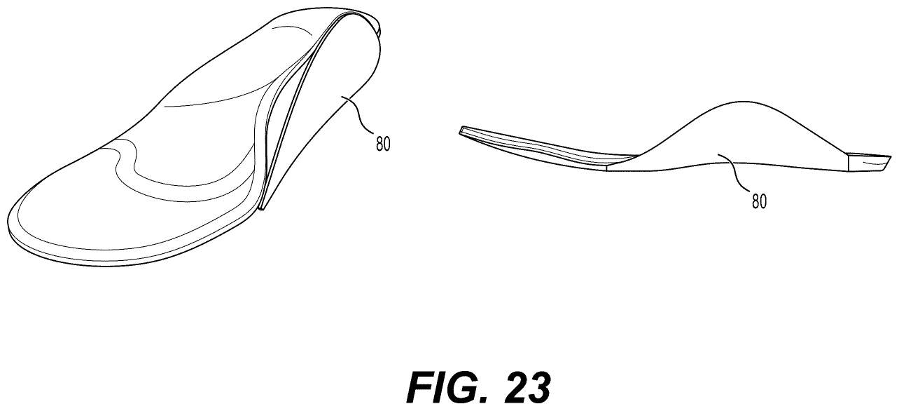

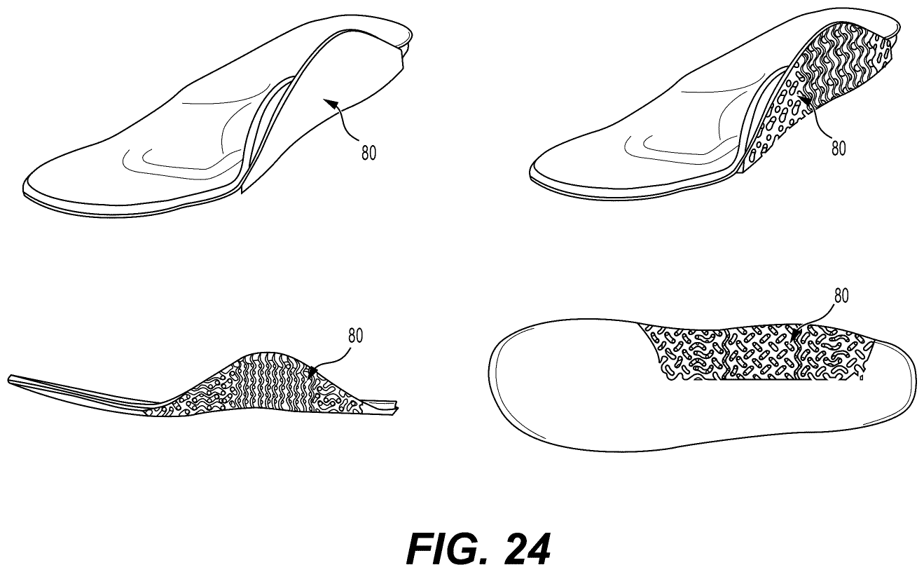

Using the data from the scan of the foot (that is, the foot shape 62) and from the plantar pressure map 54, the 3D modeling software 56 adjusts the arch portion 80 (FIGS. 11, 12). This includes the size of the arch portion 80, the shape of the arch portion 80 and, as shown in FIG. 12, the location of the arch portion 80. FIG. 12 shows the arch portion 80 being displaced longitudinally and laterally, but it is contemplated that the arch portion could also be rotated. The arch portion 80 can also be adjusted for height, stiffness (by adjusting lattice cell size and gradients in thickness of the lattice for example), and for a desired behavior of the arch portion 80. As shown in FIGS. 23 and 24 it is contemplated that in some embodiments the arch portion 80 could be solid (i.e., not containing spaces or gaps), while in other embodiments the arch portion could be latticed.

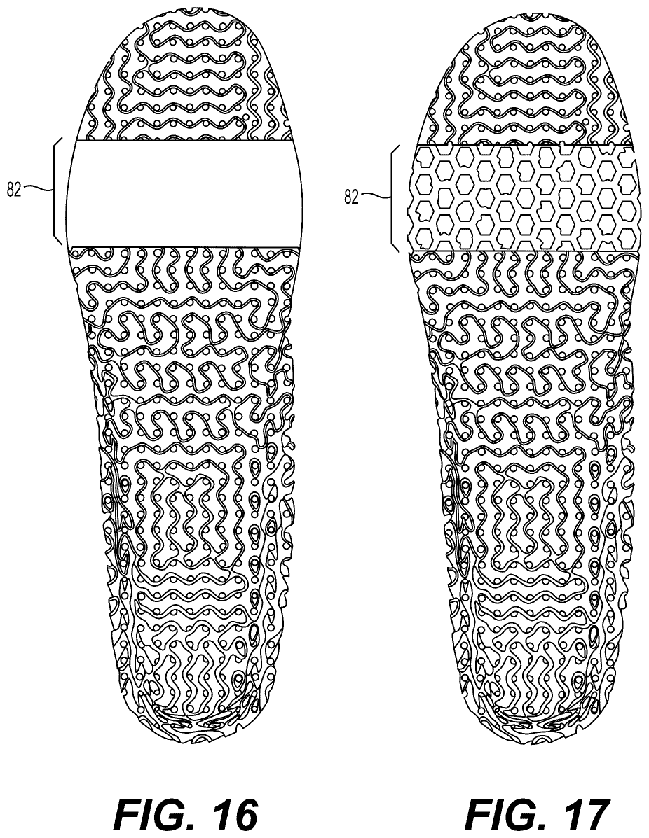

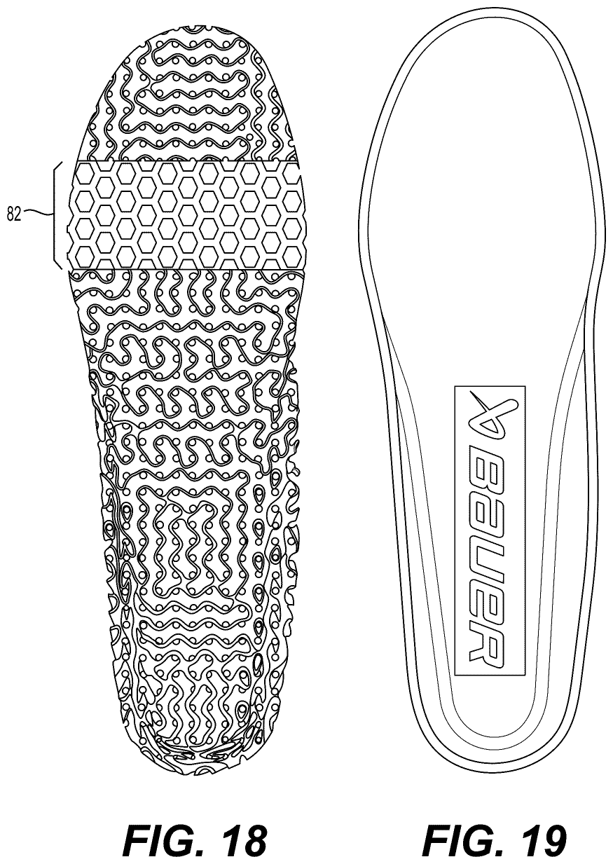

With reference to FIGS. 16 to 18, in some embodiments the 3D modeling software 56 can be configured to define a pushing plate region 82 in the footbed 3D model 76. The pushing plate region 82 is a region of smaller thickness and/or stiffer construction generally aligned with the ball B of the foot to enhance the force transmission from the foot to the ice skate to the ice. The construction of the pushing plate region 82 differs from the construction of the rest of the virtual footbed model. In FIG. 16, the pushing plate region 82 is solid (i.e., not containing spaces or gaps). In FIGS. 17 and 18, the pushing plate region 82 has a lattice type which differs from the lattice type of the footbed 3D model 76. In FIG. 17 the pushing plate region 82 has a lattice type, more specifically a honeycomb lattice, having walls with a constant thickness. In FIG. 18 the pushing plate region 82 has a lattice type, more specifically a honeycomb lattice, having walls with a variable thickness, with the wall portions of the pushing plate region 82 corresponding to regions of higher pressure in the plantar pressure map 54 being correspondingly thicker.

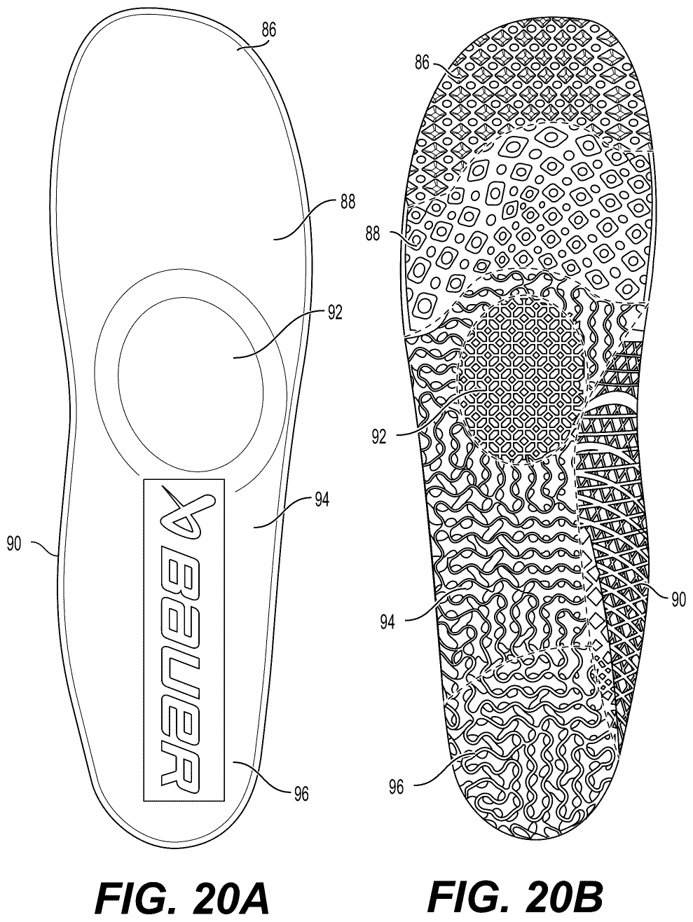

With reference to FIGS. 20A and 20B, in some embodiments the 3D modeling software 56 can be configured to define a footbed 3D model 76 having multiple distinct regions. In the embodiment shown in FIGS. 20A and 20B, the footbed 3D model 76 has six distinct regions: a toes region 86, a ball region 88, an arch region 90, a metatarsal region 92, a sole region 94, and a heel region 96, each of which is to be aligned with a corresponding portion of the foot. The different regions 86, 88, 90, 92, 94, 96 each have different lattice characteristics which are selected to obtain the desired shape, cushioning, and pressure resistance of the corresponding regions 86, 88, 90, 92, 94, 96. In the present embodiment, the sole and heel regions 94, 96 have the same lattice type, but have different lattice sizes to account for the different pressures applied in these two regions 94, 96. The lattice type of the sole and heel regions 94, 96 differs from the lattice types used in the regions 86, 88, 90, 92. The lattice types of the regions 86, 88, 90, 92 are all different from each other. It is contemplated that all of the regions 86, 88, 90, 92, 94, 96 could have different lattice types. It is also contemplated that different regions 86, 88, 90, 92 could have the same lattice type, including the lattice type used for regions 94, 96. For each region 86, 88, 90, 92, 94, 96 it is contemplated that the size of the lattices used in the region could vary. For example, the lattices could be thinner as the pressure in the corresponding pressure map increases. It is contemplated that the ball region 88 could be a push pad 82 as described above. It is contemplated that the footbed 3D model could have more or less than six distinct regions.

Returning to FIG. 7, once the footbed 3D model 76 has been generated and adjusted by the 3D modeling software as described above, in some non-limiting embodiments of the present technology, the processor 110 can be configured to provide the footbed 3D model 76 to an additive manufacturing machine 84, to which the processor 110 can be communicatively coupled either via a wired or wireless communication link. The additive manufacturing machine 84 is then configured to produce, based on the footbed 3D model 76, the custom footbed 30. The custom footbed 30 will thus be customized for the player position 68. In some non-limiting embodiments of the present technology, the additive manufacturing machine 84 can be a selective laser sintering (SLS) printer that fuses powdered plastic material together. In some embodiments, the powdered plastic material could be polyamide (PA12, P11, or PA6), thermoplastic polyurethane (TPU), polyketon, polypropylene (PP), polyether block amide (PEBA), blends of these materials. It is contemplated that the powdered plastic material could be mixed with fillers such as glass or carbon. It is contemplated that other types of powdered plastic material could be used. It is also contemplated that the material used could be a smart material such as a piezoelectric material that produces a voltage when stressed or an electroactive polymer (EAP) that changes in volume or in another property when a current is applied to it. It is also contemplated that other types of additive manufacturing machines could be used. It is contemplated that is some embodiment, one or more post-processing steps could be performed on the custom footbed 30 produced by the additive manufacturing machine 84. These include, but are not limited to, removing supports and/or excess material, coloring, washing, smoothing, surface finishing, and laminating fabric on the custom footbed 30.

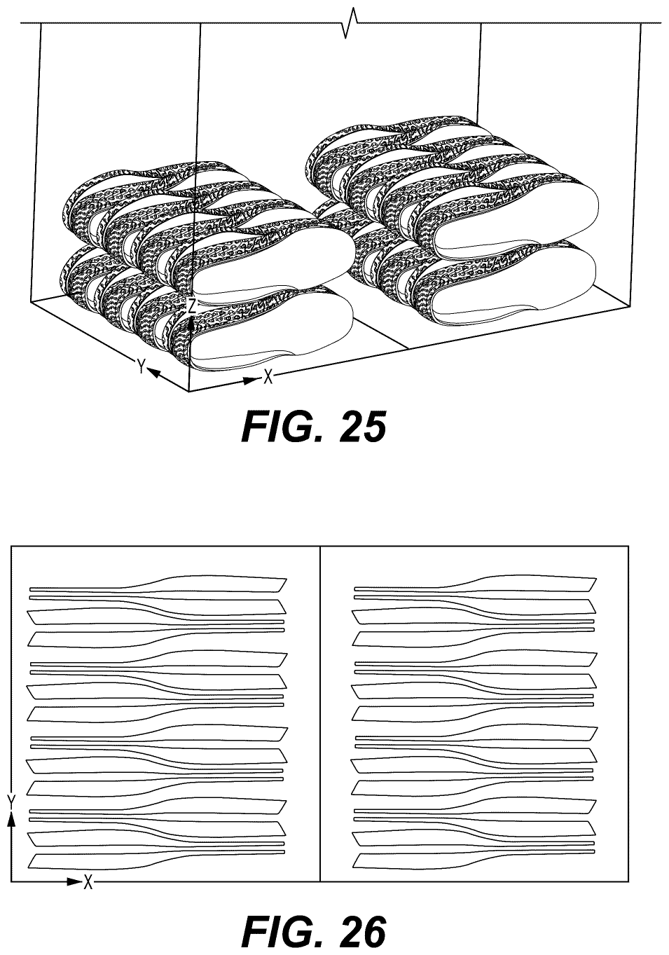

With reference to FIGS. 25 and 26, it is contemplated that the additive manufacturing machine 84 could produce multiple footbeds during a common additive manufacturing operation. The footbeds could all be from the same virtual footbed model or could be from different virtual footbed models.

With reference to FIG. 27, there is depicted a computer system 100 suitable for use with some implementations of the present technology. The computer system 100 comprises various hardware components including one or more single or multi-core processors collectively represented by processor 110, a graphics processing unit (GPU) 111, a solid-state drive 120, a random-access memory 130, a display interface 140, and an input/output interface 150.

Communication between the various components of the computer system 100 may be enabled by one or more internal and/or external buses 160 (e.g., a PCI bus, universal serial bus, IEEE 1394 “Firewire” bus, SCSI bus, Serial-ATA bus, etc.), to which the various hardware components are electronically coupled.

The input/output interface 150 may be coupled to a touchscreen 190 and/or to the one or more internal and/or external buses 160. The touchscreen 190 may be part of the display. In some embodiments, the touchscreen 190 is the display. In the embodiments illustrated in FIG. 27, the touchscreen 190 comprises touch hardware 194 (e.g., pressure-sensitive cells embedded in a layer of a display allowing detection of a physical interaction between a user and the display) and a touch input/output controller 192 allowing communication with the display interface 140 and/or the one or more internal and/or external buses 160. In some embodiments, the input/output interface 150 may be connected to a keyboard (not shown), a mouse (not shown) or a trackpad (not shown) allowing the user to interact with the computer system 100 in addition to or instead of the touchscreen 190. In some embodiments, the computer system 100 may comprise one or more microphones (not shown). The microphones may record audio, such as user utterances. The user utterances may be translated to commands for controlling the computer system 100.

It is noted some components of the computer system 100 can be omitted in some non-limiting embodiments of the present technology. For example, the touchscreen 190 can be omitted.

According to implementations of the present technology, the solid-state drive 120 stores program instructions suitable for being loaded into the random-access memory 130 and executed by the processor 110 and/or the GPU 111. For example, the program instructions may be part of a library or an application.

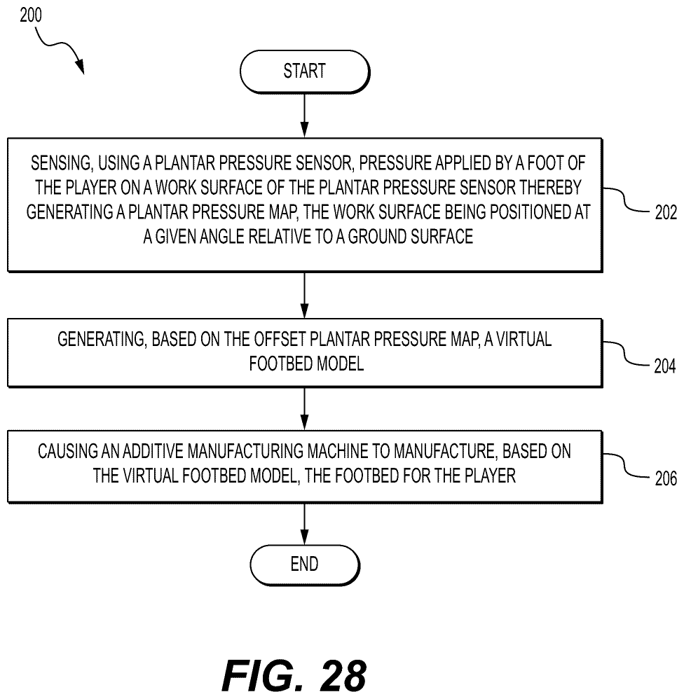

Given the architecture and examples provided herein, it is now possible to implement a method for manufacturing a footbed or a skate of a player, such as the custom footbed 30. With reference to FIG. 28, there is depicted a flowchart diagram of a method 200, in accordance with certain non-limiting embodiments of the present technology. Akin to the method 50, the method 200 can be executed by the processor 110 of the computer system 100.

The method 200 commences at step 202 with the processor 110 being configured to sense, using the plantar pressure sensor 52, pressure applied by the foot of the person (such as a hockey player) for whom the custom footbed 30 is to be designed and manufactured.

According to certain non-limiting embodiments of the present technology, as described above with reference to FIGS. 8 and 9, the plantar pressure sensor 52 has a work surface that is positioned at an angle to a ground surface, on which the pressure plantar sensor 52 is disposed—that is, the angled surface 58. Thus, by sensing the pressure applied by the foot using the plantar pressure sensor 52 having the angled surface 58, the processor 110 can be configured to generate an offset plantar pressure map, that is, the plantar pressure map 54 mentioned above reference to FIG. 10.

The plantar pressure map 54 is representative of the pressure applied by the foot being offset relative to that pressure which would have been represented by a regular plantar pressure map, generated by a similar plantar pressure sensor, however having a work surface positioned substantially in parallel to the ground surface.

In some non-limiting embodiments of the present technology, prior to sensing the pressure applied to the plantar pressure sensor 52, the processor 110 can be configured to determine the angle at which the angled surface 58 of the plantar pressure sensor 52 needs to be positioned relative to the ground surface, on which the plantar pressure sensor 52 is disposed, for generating the plantar pressure map 54. In some non-limiting embodiment of the present technology, the processor 110 can be configured to determine this angle based on the skating stride of the person for whom the custom footbed 30 is to be designed and manufactured. Thus, the processor 110 can be configured to: (i) obtain, such as from the database or the operator of the computer system 100, data of the skating stride of the person; (ii) determine, based on the skating stride associated with the person, the given angle for positioning the angled surface 58 relative to the ground surface; (iii) cause the plantar pressure sensor 52 to position the angled surface 58 at the given angle; and (iv) cause the plantar pressure sensor 52 to generate the plantar pressure map 54 while the angled surface 58 is positioned at the given angle relative to the ground surface.

Also, in some non-limiting embodiments of the present technology, at step 202, the processor 110 can be configured to acquire the foot shape 62, the contour shape 66, the player position 68, the customization features 70, player preferences 72, and the orthotic needs 74 for the person for whom the custom footbed 30 is to be designed and manufactured. In one example, the processor 110 can be configured to acquire these data from the database (not separately depicted), which could be communicatively coupled to the computer system 100. In another example, these data can be provided to the processor 110 by the operator of the computer system 100.

The method 200 then advances to step 204.

At step 204, according to certain non-limiting embodiments of the present technology, the processor 110 can be configured, to provide to the 3D modeling software 56 the plantar pressure map 54 generated at step 202. In response, the 3D modeling software 56 can be configured to generate, based at least on the plantar pressure map 54, the virtual footbed model of the custom footbed 30—such as the footbed 3D model 76 mentioned above with reference to FIG. 7. As mentioned hereinabove, the 3D modeling software 56 can be implemented, for example, as an nTop Platform™ from nTopology Inc.

In some non-limiting embodiments of the present technology, to generate the footbed 3D model 76, along with the plantar pressure map 54, the processor 110 can be configured to provide, to the 3D modeling software 56, at least some of the other data associated with the person for whom the custom footbed 30 is to be designed and manufactured that have been acquired at step 202.

Also, in some non-limiting embodiments of the present technology, the processor 110 executing the 3D modeling software 56 can be configured to generate the footbed 3D model 76 for the custom footbed 30 based on more than one plantar pressure maps. More specifically, in these embodiments, the processor 110 can be configured to: (i) modify the given angle, based on which the plantar pressure map 54 has been generated, thereby determining the other angle; (ii) reposition the angled surface 58 at the other angle relative to the ground surface, on which the plantar pressure sensor 52 is disposed; (iii) cause the plantar pressure sensor 52 to generate the other plantar pressure map (not separately depicted) while the angled surface 58 is positioned at the other angle relative to the ground surface; and (iv) generate the footbed 3D model 76 based on the combination of the plantar pressure map 54 and the other plantar pressure map. In some non-limiting embodiments of the present technology, the combination of the plantar pressure map 54 and the other plantar pressure map can comprise an average plantar pressure map thereof.

The method 200 then advances to step 206.

At step 206, according to certain non-limiting embodiments of the present technology, the processor 110 can be configured to feed the footbed 3D model 76 to the additive manufacturing machine 84, thereby causing the additive manufacturing machine 84 to manufacture the custom footbed 30 according to the footbed 3D model 76. In some non-limiting embodiments of the present technology, the additive manufacturing machine 84 can be a selective laser sintering (SLS) printer that fuses powdered plastic material together.

The method 200 then terminates.

Modifications and improvements to the above-described embodiments of the present technology may become apparent to those skilled in the art. The foregoing description is intended to be exemplary rather than limiting. The scope of the present technology is therefore intended to be limited solely by the appended claims.

1. A method for manufacturing a footbed for a hockey skate comprising:
obtaining data from at least one of a scan of a foot and a plantar pressure map of the foot;
obtaining a player position of a player for whom the footbed is to be manufactured;
generating a virtual footbed model based on the data and the player position; and
causing an additive manufacturing machine to manufacture, based on the virtual footbed model, the footbed for the hockey skate.

2. The method of claim 1, wherein the player position is one of forward, defenseman and goalie.

3. The method of claim 1, wherein for a given scan of the foot and a given plantar pressure map, the virtual footbed model generated for the player position being goalie is at least one of:
more cushioned in a region aligned with a ball region of the foot than for the player position being forward or defenseman; and
designed for greater lateral push than for the player position being forward or defenseman.

4. The method of claim 1, wherein the generating the virtual footbed model comprises adjusting at least one of a size and a location of an arch portion of the virtual footbed model based on the data.

5. The method of claim 1, wherein the generating the virtual footbed model comprises increasing a density of the virtual footbed model in regions of the virtual footbed model corresponding to regions of higher pressure in the plantar pressure map.

6. The method of claim 1, wherein the additive manufacturing machine is a selective laser sintering printer.

7. A footbed manufactured according to the method of claim 1.

8. The footbed of claim 7, comprising a pushing plate region in alignment with a ball region of the foot; and
wherein a lattice-type of the pushing plate region differs from a lattice-type of other regions of the footbed.

9. The footbed of claim 7, wherein:
a top of the footbed is a closed surface; and
a bottom of the footbed exposes a lattice of the footbed.

10. The footbed of claim 7, wherein walls of at least one portion of a lattice of the footbed are angled at an angle generally corresponding to an angle of a force applied by a foot of a skater for whom the footbed is designed on the at least one portion.

11.-34. (canceled)
